(19) United States
(12) Patent Application Publication
(10) Pub. No.: US 2016/0070503 A1
(43) Pub. Date: Mar. 10, 2016

(54) MEMORY SYSTEM

(71) Applicant: Kabushiki Kaisha Toshiba, Minato-ku (JP)

(72) Inventors: Motohiro MATSUYAMA, Hino (JP); Yoshihisa KOJIMA, Kawasaki (JP)

(73) Assignee: Kabushiki Kaisha Toshiba, Minato-ku (JP)

(21) Appl. No.: 14/640,371

(22) Filed: Mar. 6, 2015

Related U.S. Application Data
(60) Provisional application No. 62/048,582, filed on Sep. 10, 2014.

(51) Int. Cl. G06F 3/06

(52) U.S. Cl. CPC G06F 3/0625; G06F 3/0688; G06F 3/0656; G06F 3/0634

(57) ABSTRACT

According to one embodiment, a memory system includes a nonvolatile memory, a buffer memory, a power management unit, and a controller. The buffer memory is divided into a plurality of first subbuffers. The power management unit acquires a power consumption value. The power management unit starts and stops power supply to the first subbuffers with respect to each first subbuffer, based on the acquired power consumption value. The controller selects a second subbuffer from one or more third subbuffers being supplied with power. The controller buffers transfer data between the outside and the nonvolatile memory in the second subbuffer.

### CROSS-REFERENCE TO RELATED APPLICATIONS

This application is based upon and claims the benefit of priority from U.S. Provisional Patent Application No. 62/048,582, filed on Sep. 10, 2014; the entire contents of which are incorporated herein by reference.

### FIELD

Embodiments described herein relate generally to a memory system.

### BACKGROUND

Conventionally, power consumption of a memory system such as a solid state drive (SSD) include power consumed by a leakage current, in addition to power consumed with data transfer. The leakage current is a current flowing through a portion which is supposed to be insulated. The current leakage occurs regardless of whether data transfer is ongoing.

### BRIEF DESCRIPTION OF THE DRAWINGS

FIG. 1 is a diagram illustrating an exemplary configuration of a memory system of an embodiment;

FIG. 2 is a diagram illustrating an exemplary configuration of a buffer power management unit;

FIG. 3 is a diagram illustrating an exemplary data configuration of state definition information;

FIG. 4 is a flowchart explaining an operation of a state transition by the buffer power management unit;

FIG. 5 is a flowchart explaining an operation of power control with respect to each subbuffer; and

FIG. 6 is a flowchart explaining one example of operations of buffer allocation by a command controller.

### DETAILED DESCRIPTION

In general, according to an embodiment described herein, a memory system includes a nonvolatile memory, a buffer memory, a power management unit, and a controller. The buffer memory is divided into a plurality of first subbuffers. The power management unit acquires a power consumption value. The power management unit starts and stops power supply to the first subbuffers with respect to each first subbuffer, based on the acquired power consumption value. The controller selects a second subbuffer from one or more third subbuffers being supplied with power. The controller buffers transfer data between the outside and the nonvolatile memory in the second subbuffer.

Exemplary embodiments of a memory system will be explained below in detail with reference to the accompanying drawings. The present invention is not limited to the following embodiments.

### Embodiment

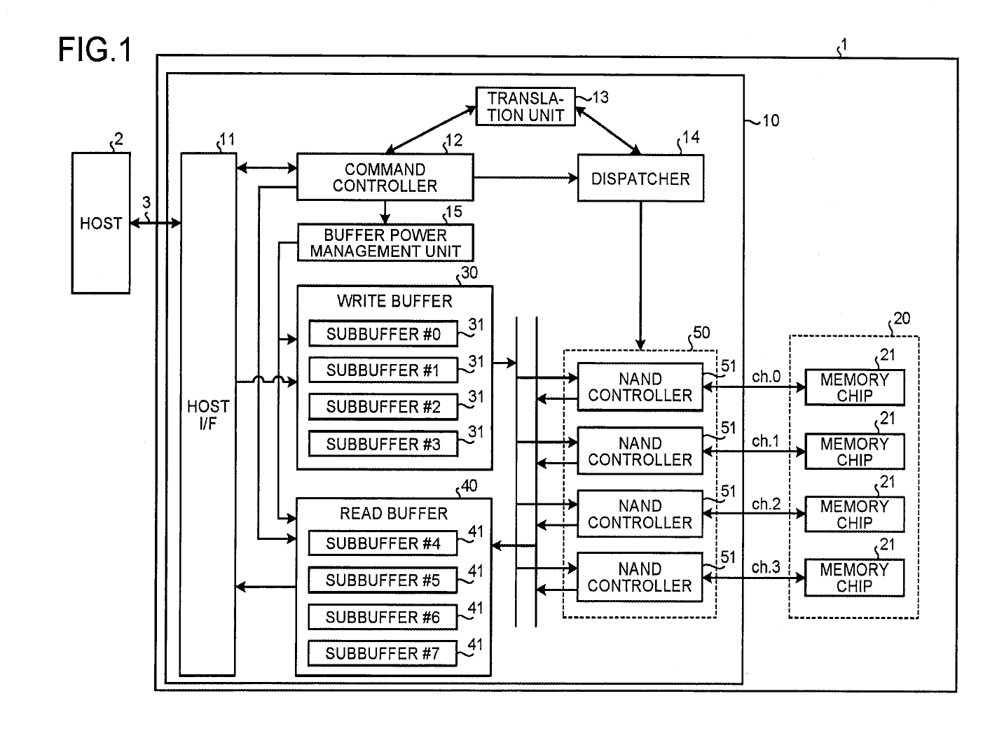

FIG. 1 is a diagram illustrating an exemplary configuration of a memory system of an embodiment. A memory system 1 is connected to a host 2 through a communication channel 3. The host 2 is a computer. The computer described herein includes a personnel computer, a portable computer, or a mobile communication device, for example. The memory system 1 functions as an external storage device of the host 2. As an interface standard of the communication channel 3, any standard is applicable. The host 2 can issue a host command to the memory system 1. The host command includes, for example, a write command and a read command. The write command and the read command include logical address information (logical address) specifying access destination.

The memory system 1 includes a memory controller 10, and a NAND-type flash memory (NAND memory) 20 used as a storage. The type of a memory used as a storage is not limited to the NAND-type flash memory, as long as a nonvolatile memory is used. For example, a NOR-type flash memory, a resistance random access memory (ReRAM) or a magnetoresistive random access memory (MRAM) can be used as a storage.

The NAND memory 20 includes one or more memory chips 21. The NAND memory 20 herein includes four memory chips 21. Each of the memory chips 21 includes a memory cell array in which data is to be programmed.

Each of the four memory chips 21 constituting the NAND memory 20 is connected to the memory controller 10 through any of four channels (ch.0 to ch.3). Each of the memory chips 21 is connected to only one among the four channels. Each of the channels includes a wiring group including an I/O signal line and a control signal line. The I/O signal line is, for example, a signal line for sending/receiving data, an address, and a command. The control signal line is, for example, a signal line for sending/receiving a write enable (WE) signal, a read enable (RE) signal, a command latch enable (OLE) signal, an address latch enable (ALE) signal, and a write protect (WP) signal. The memory controller 10 can individually control each of the channels. The memory controller 10 can simultaneously operate the four memory chips 21 connected to different channels, by individually and simultaneously controlling the four channels. Each of the channels may be connected to a plurality of the memory chips 21.

The memory controller 10 includes a host interface (host I/F) 11, a command controller 12, a translation unit 13, a dispatcher 14, a buffer power management unit 15, a write buffer 30, a read buffer 40, and a NAND controller group 50. Some or all of the command controller 12, the translation unit 13, the dispatcher 14, and the buffer power management unit 15 are realized by software or hardware, or combination thereof. Realizing a functional unit by software means that a processor implements an operation of the functional unit based on a program.

The write buffer 30 and the read buffer 40 are a buffer memory for data transfer between the host 2 and the NAND memory 20. More specifically, the write buffer 30 is used to transfer data from the host 2 to the NAND memory 20. The read buffer 40 is used to transfer data from the NAND memory 20 to the host 2. As the write buffer 30 and the read buffer 40, a memory enabling a high speed operation is employed. As the write buffer 30 and the read buffer 40, for example, a static random access memory (SRAM) is employed.

A host I/F 11 sends a host command, which has been received from the host 2, to the command controller 12, and sends a wait command, which has been issued by the command controller 12, to the host 2. The wait command is a command for making the host 2 keep on standby for sending data (or a host command). In the case where the host 2 employs, as an interface standard of the communication channel 3, a standard (for example, serial attached SCSI (SAS)) in which data is sent in response to a notification of readiness to receive data from a device, the host I/F 11 may make the host 2 keep on standby for sending data by not sending the notification of readiness to receive data to the host 2, instead of sending a wait command. Also, the host I/F 11 transfers data from the host 2 to the write buffer 30 and transfers data from the read buffer 40 to the host 2.

The NAND controller group 50 includes four NAND controllers 51 which are connected to different channels, respectively. Each of the four NAND controllers 51 transfers data from the memory chip 21, which is connected to the NAND controllers 51 through the channel, to the read buffer 40, and transfers data from the write buffer 30 to the memory chip 21, which is connected to the NAND controllers 51 through the channel.

The translation unit 13 translates, based on an instruction from the command controller 12, a logical address included in an access command from the host 2 into physical address information (a physical address) in the NAND memory 20. The physical address after translation indicates a storage position of data from the host 2. The physical address after translation is sent to the dispatcher 14.

The command controller 12 receives a host command through the host I/F 11. The command controller 12 controls data transfer by the host I/F 11, based on the received host command. Also, the command controller 12 controls, through the dispatcher 14, data transfer by the NAND controller group 50.

The dispatcher 14, under the control of the command controller 12, instructs any of the four NAND controllers 51 to transfer data between the NAND memory 20 and the buffers (the write buffer 30 or the read buffer 40). The dispatcher 14 determines the NAND controller 51 to be instructed, based on the physical address translated by the translation unit 13.

Each of the NAND controllers 51 generates a command (a NAND command) for the corresponding memory chip 21 connected to the NAND controller 51 through the channel, based on an instruction received from the dispatcher 14. Each of the NAND controllers 51 sends the generated NAND command to the corresponding memory chip 21 connected to the NAND controller 51 through the channel. The NAND command at least includes a command to program data in the memory cell array (program command) and a command to read data from the memory cell array (read command).

The NAND controller 51 acquires, from the write buffer 30, data to be sent to the memory chip 21 with the program command. Also, the NAND controller 51 stores, in the read buffer 40, data received from the memory chip 21 in response to the read command. A data storage position in the write buffer 30 and the read buffer 40 is determined by buffer allocation (to be described hereinafter) by the command controller 12. When the read command is processed, the determined storage position is to be notified from the command controller 12 through the dispatcher 14.

According to an embodiment, the write buffer 30 is divided into a plurality of (herein four) subbuffers 31. The four subbuffers 31 are distinguished from one another by numbering #0 to #3 at the end of the name. Power supply to each of the subbuffers #0 to #3 can be individually started/stopped. Start/stop of power supply to each of the subbuffers #0 to #3 is executed by the buffer power management unit 15.

Also, the read buffer 40 is divided into a plurality of (herein four) subbuffers 41. The four subbuffers 41 are distinguished from one another by numbering #4 to #7 at the end of the name. Power supply to each of the subbuffers #4 to #7 can be individually started/stopped. Start/stop of power supply to each of the subbuffers #4 to #7 is executed by the buffer power management unit 15.

The buffer power management unit 15 starts/stops power supply to the subbuffers #0 to #7, as described above. Multiple states with a different number of subbuffers to be supplied with power are defined beforehand. The buffer power management unit 15 changes a state among the multiple states.

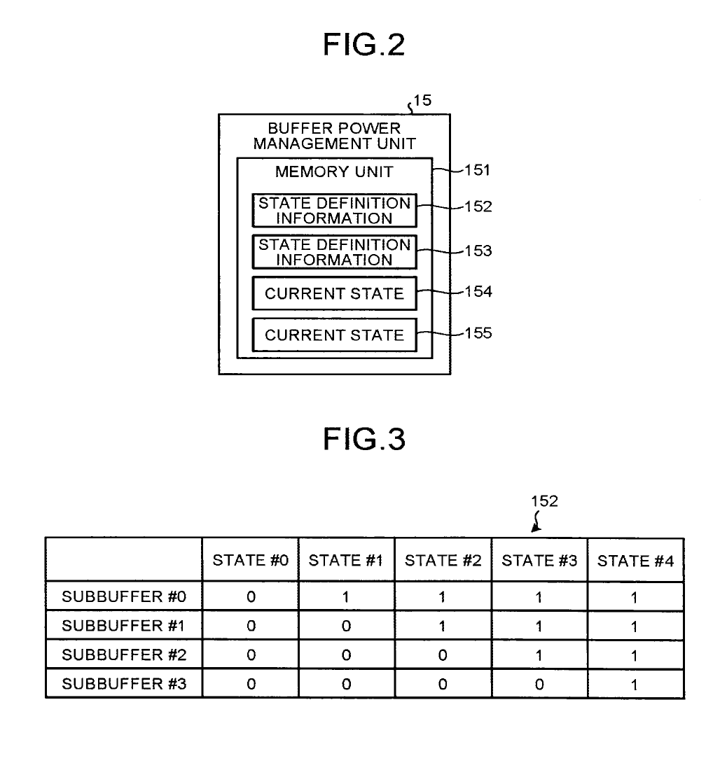

FIG. 2 is a diagram illustrating an exemplary configuration of the buffer power management unit 15. As illustrated in FIG. 2, the buffer power management unit 15 has a memory unit 151. The memory unit 151 includes, for example, a small-scale memory or a register. The memory unit 151 stores a state definition information 152 for the write buffer 30, a state definition information 153 for the read buffer 40, a current state 154 of the write buffer 30, and a current state 155 of the read buffer 40. The state definition information 152 and the state definition information 153 are set beforehand.

FIG. 3 is a diagram illustrating an exemplary data configuration of the state definition information 152. According to this example, five states (sates #0 to #4) are defined. Each cell stores a state of each subbuffer constituting each state. Hereinafter, the state of each subbuffer is called an individual state. An individual state “0” indicates a state in which power is not supplied, and an individual state “1” indicates a state in which power is supplied. The state #0 is a state in which power is not supplied to any of the subbuffers #0 to #3. The state #1 is a state in which power is supplied only to the subbuffer #0. The state #2 is a state in which power is supplied to the subbuffers #0 and #1, and not supplied to the subbuffers #2 and #3. The state #3 is a state in which power is supplied to the subbuffers #0 to #2 and not supplied to the subbuffer #3. The state #4 is a state in which power is supplied to all of the subbuffers #0 to #3.

The current state 154 indicates a current value among the states #0 to #4.

The state definition information 153 and the current state 155 are similar to the state definition information 152 and the current state 154, except that a target buffer is different, and therefore detailed explanation will be omitted.

The command controller 12 executes the buffer allocation. The buffer allocation is a process to determine a buffering position of transfer data from among the buffers (the write buffer 30 and the read buffer 40) when data is transferred between the host 2 and the NAND memory 20. Since the buffers are herein divided into multiple subbuffers (the subbuffers #0 to #7), the buffer allocation includes a process to select one subbuffer to be used for buffering of the transfer data from subbuffers being supplied with power among the subbuffers #0 to #7. The command controller 12 allocates, to data from the host 2, a subbuffer 31 among the subbuffers #0 to #3, of which individual state is set to “1” in the state indicated by the current state 154. Also, the command controller 12 allocates, to data from the NAND memory 20, a subbuffer 41 among the subbuffers #4 to #7, of which individual state is set to “1” in the state indicated by the current state 155.

Next, an operation of the memory system 1 of an embodiment will be described. For simplicity, only the write buffer 30 is herein described.

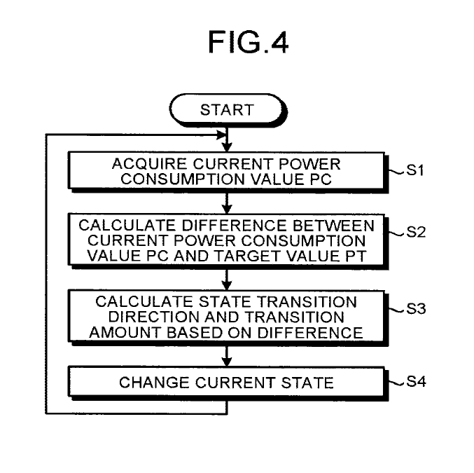

FIG. 4 is a flowchart explaining an operation of a state transition by the buffer power management unit 15. The buffer power management unit 15 first acquires a current power consumption value Pc (S1). The buffer power management unit 15 may acquire the current power consumption value Pc by actual measurement, or estimate it by calculation.

For example, the power consumption Pc is acquired by adding up a leakage power P1 and a dynamic power P2. The leakage power P1 is a power loss caused by current leakage occurring in a buffer. The current leakage occurs in a subbuffer 31 being supplied with power, and does not occur in a subbuffer 31 in which power supply is stopped. The number of subbuffers being supplied with power differs from state to state. More specifically, the leakage power P1 changes depending on the current state 154. Also, the leakage current tends to increase with the increase in the temperature of a circuit constituting a buffer. Therefore, the leakage power P1 is calculated by the following formula:

P1=f(c-state,T) (1)

T is herein a junction temperature of a circuit constituting a buffer, for example. For example, a temperature sensor is provided near the write buffer 30. The buffer power management unit 15 may calculate the junction temperature T by correcting a value detected by the temperature sensor, with a predetermined calculation. If the temperature sensor is arranged away from the write buffer 30 (for example, a position away from the memory controller 10 in the memory system 1), the buffer power management unit 15 may estimate the junction temperature T based on a predetermined relational expression and the value detected by the temperature sensor. Any method for detecting a temperature by the temperature sensor may be employed. Also, the buffer power management unit 15 may calculate the junction temperature T by use of a thermal resistance. Also, c-state is a state indicated by the current state 154.

The dynamic power P2 is power consumed by data transfer in the memory system 1. The dynamic power P2 includes power consumed by programming and reading in each of the memory chips 21. In other words, the dynamic power P2 tends to increase as performance improves. Therefore, the dynamic power P2 is calculated by the following formula:

P2=f(performance) (2)

As the performance, any index can be used as long as the index is correlated with a data transfer amount per unit time. Examples of the index as the performance include the number of times a host command is processed per unit time, a data transfer speed between the host 2 and the memory system 1, or a data transfer speed between the memory controller 10 and the NAND memory 20.

The buffer power management unit 15 calculates the leakage power P1 by using the formula (1) and calculates the dynamic power P2 by using the formula (2). The buffer power management unit 15 calculates the current power consumption value Pc by adding up P1 and P2. The formulas (1) and (2) are derived by, for example, an experiment or a simulation in advance, and set to the memory system 1 in advance. Also, a relation indicated by the formula (1) and/or a relation indicated by the formula (2) may be described in a look-up table and set in the memory system 1.

Subsequently, the buffer power management unit 15 calculates a difference between the current power consumption value Pc and a target power consumption value Pt (S2). The target power consumption value Pt is set to the buffer power management unit 15 in advance, for example. As an example herein, the difference is obtained by subtracting the target power consumption value Pt from the current power consumption value Pc. The buffer power management unit 15 calculates a state transition direction and a transition amount, based on the difference (S3). For example, if the difference is a positive value, the buffer power management unit 15 determines the transition direction so that the number of subbuffers to be supplied with power is decreased. If the difference is a negative value, the buffer power management unit 15 determines the transition direction so that the number of subbuffers to be supplied with power is increased. Also, the buffer power management unit 15 determines a transition amount so that the number of subbuffers to be supplied with power changes more as an absolute value of the difference increases. A transition amount for a state transition from a state #1 to a state #(i+a) or a state #(i−a) is assumed to be “a”.

Next, the buffer power management unit 15 changes the current state 154 based on the calculated transition direction and the transition amount (S4). Then, the buffer power management unit 15 again executes S1. The buffer power management unit 15 may wait for a predetermined time between executing S4 and executing S1.

As described herein, the buffer power management unit 15 changes a state in a direction for reducing the number of subbuffers to be supplied with power, when the current power consumption value Pc exceeds the target power consumption value Pt. Also, the buffer power management unit 15 changes a state in a direction for increasing the number of subbuffers to be supplied with power, when the current power consumption value Pc is below the target power consumption value Pt. Also, the buffer power management unit 15 changes the number of subbuffers to be supplied with power by changing a state. The larger the difference between the current power consumption value Pc and the target power consumption value Pt is, the more the number of subbuffers to be supplied with power is changed.

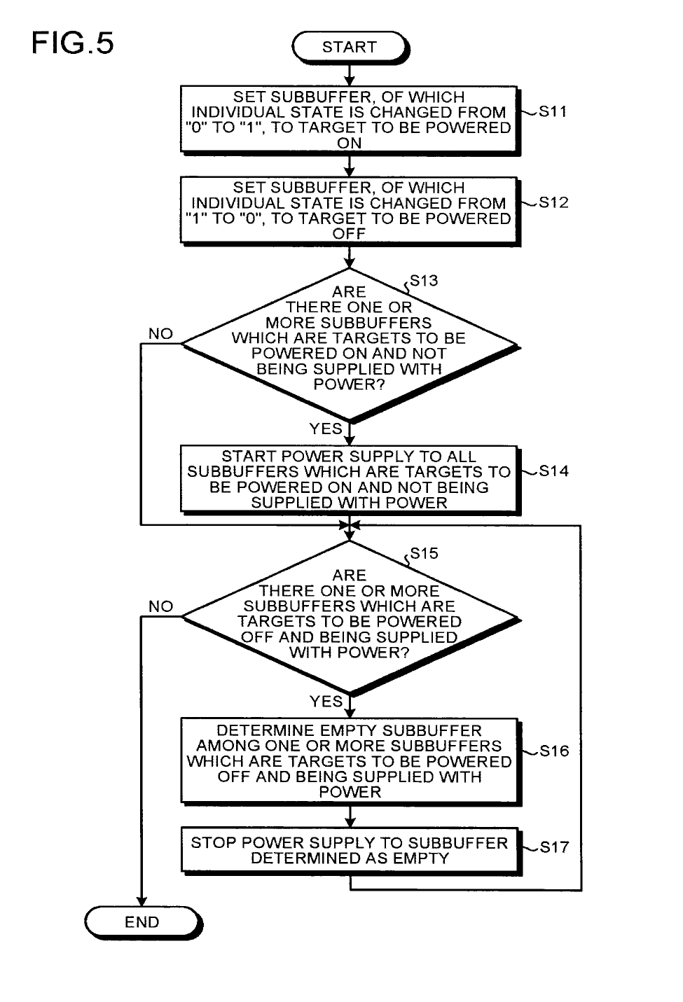

FIG. 5 is a flowchart explaining an operation of power control with respect to each subbuffer 31. The buffer power management unit 15 executes an operation illustrated in FIG. 5 every time a state transition is executed.

In the case where there is a subbuffer 31 of which individual state is changed from “0” to “1”, the buffer power management unit 15 sets a subbuffer 31, of which individual state is changed from “0” to “1”, to a target to be powered on (S11). For example, if a state is changed from a state #1 to a state #3, each of a subbuffer #1 and a subbuffer #2 is set to a target to be powered on.

Also, in the case where there is a subbuffer 31 of which individual state is changed from “1” to “0”, the buffer power management unit 15 sets a subbuffer 31, of which individual state is changed from “1” to “0”, to a target to be powered off (S12). For example, if a state is changed from a state #4 to a state #3, a subbuffer #4 is set to a target to be powered off.

Next, the buffer power management unit 15 determines whether there are one or more subbuffers 31 which are targets to be powered on and are not being supplied with power (S13). The buffer power management unit 15 can recognize, by monitoring with respect to each subbuffer 31, whether power is being supplied.

In the case where there are one or more subbuffers 31 which are targets to be powered on and are not being supplied with power (S13, Yes), the buffer power management unit 15 starts power supply to all subbuffers 31 which are targets to be powered on and are not being supplied with power (S14). If all subbuffers 31 which are targets to be powered on are being supplied with power (S13, No), the buffer power management unit 15 skips the operation of S14. If there is no target to be powered on, the buffer power management unit 15 makes a “No” determination in the determination process of S13.

Next, the buffer power management unit 15 determines whether there are one or more subbuffer 31 which are targets to be powered off and are being supplied with power (S15). If there are one or more subbuffer 31 which are targets to be powered off and are being supplied with power (S15, Yes), the buffer power management unit 15 determines an empty subbuffer 31 among the one or more subbuffer 31 which are targets to be powered off and are being supplied with power (S16). After data transfer from the subbuffers 31 to the NAND memory 20 is completed, the data, which has been transferred, is deleted from the subbuffers 31. “Empty” as used herein means a state in which all data in the subbuffers 31 have been transferred.

Next, the buffer power management unit 15 stops power supply to a subbuffer 31, which has been determined as empty (S17), and again executes the determination process of S15.

If any of the targets to be powered off are not being supplied with power (S15, No), the buffer power management unit 15 finishes starting and stopping power supply to each subbuffer 31. If there is no target to be powered off, the buffer power management unit 15 makes a “No” determination in the determination process of S15.

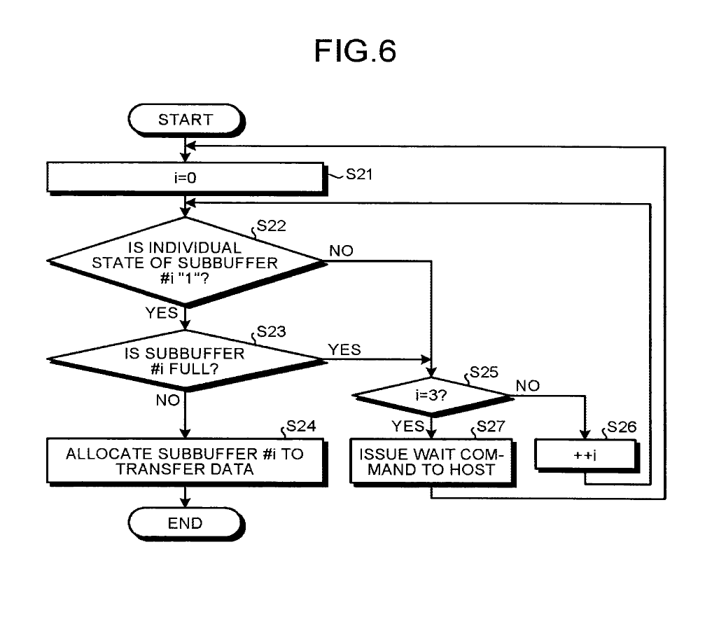

FIG. 6 is a flowchart explaining an example of an operation of buffer allocation by the command controller 12. The buffer allocation is performed when the command controller 12 has an unprocessed write command.

First, the command controller 12 initializes a parameter i to “0” (S21). Next, the command controller 12 determines whether an individual state of a subbuffer #i is “1” (S22). The command controller 12 executes the determination process of S22 with reference to the current state 154 and the state definition information 152.

If the individual state of the subbuffer #i is “1” (S22, Yes), the command controller 12 determines whether the subbuffer #i is full (S23). “Full” as used herein means that there is no available space. If the subbuffer #i is not full (S23, No), the command controller 12 allocates an available space of the subbuffer #i to data from the host 2 (S24) and finishes an operation of buffer allocation.

If the individual state of the subbuffer #i is “0” (S22, No), or the subbuffer #i is full (S23, Yes), the command controller 12 determines whether a value of the parameter i is “3” which is maximum number among the numbers numbered to the four subbuffers 31 (S25). If the value of the parameter i is not “3” (S25, No), the command controller 12 increments the value of the parameter i by “1” (S26), and again executes a process of step S22.

If the value of the parameter i is “3” (S25, Yes), the command controller 12 issues a wait command to the host 2 (S27), and again executes a process of step S21. The host 2 keeps on standby for sending data, upon receipt of the wait command. When executing the process of S24 after once sending a wait command, the command controller 12 may send, to the host 2, a command to allow sending data. Accordingly, the command controller 12 can make the host 2 keep on standby for sending data until any of the subbuffers 31, of which individual state is “1”, has an available space.

Thus, according to an embodiment, the buffer power management unit 15 starts and stops power supply to multiple subbuffers 31 on a subbuffer 31 basis, based on the current power consumption value Pc. The command controller 12 allocates a subbuffer 31 being supplied with power among the multiple subbuffers 31 to transfer data between the host 2 and the HAND memory 20. Therefore, in the case where the current power consumption value Pc exceeds the target value Pt, the memory system 1 can lower the current power consumption value Pc to the target value Pt by reducing power consumption by a leakage current.

Examples of a method to be compared with the present embodiment for adjusting power consumption of the whole memory system include a method by adjusting performance (hereinafter called a comparative example). According to the comparative example, in the case where the current power consumption value Pc exceeds the target value Pt, the dynamic power P2 is controlled by actively degrading performance. Actively degrading performance specifically means, in the case of a write command, actively decreasing a data transfer amount per unit time by making the host 2 keep on standby for sending data (or a host command). Also, in the case of a read command, actively degrading performance means actively decreasing a data transfer amount per unit time by stopping sending data (or a response) to the host 2. According to the comparative example, total power consumption is reduced without controlling power consumption by a leakage current. According to the embodiment, in the case where the current power consumption value Pc exceeds the target value Pt, performance degradation can be reduced, compared with the comparative example, since power consumption of the memory system 1 is reduced by controlling power consumption by a leakage current P1.

The buffer power management unit 15 reduces the number of subbuffers 31 being supplied with power if the current power consumption value Pc is higher than the target value Pt, and increases the number of subbuffers 31 being supplied with power if the current power consumption value Pc is lower than the target value Pt. The memory system 1 can operate so that power consumption coincides with the target value Pt by adjusting power consumption by a leakage current.

Also, the buffer power management unit 15 changes the number of the subbuffers 31 being supplied with power by executing a state transition. The larger the difference between the current power consumption value Pc and the target value Pt is, the more the number of the subbuffers 31 being supplied with power is changed. As a result, the memory system 1 can efficiently control power consumption.

Also, the buffer power management unit 15 stores the state definition information 153, which is recorded definitions of multiple states each with a different number of the subbuffers 31 to be supplied with power. The buffer power management unit 15 executes a state transition among multiple states based on the current power consumption value Pc. As a result, the memory system 1 can efficiently control power consumption.

Also, the state definition information 153 defines, for each of the multiple subbuffers 31, either “1” indicating that power is supplied or “0” indicating that power is not supplied. Accordingly, the buffer power management unit 15 can easily determine a target to be powered on and a target to be powered off. It should be noted that subbuffers 31 being supplied with power may not be defined for each state. For example, only the number of the subbuffers 31 being supplied with power may be defined for each state in advance. Then, when a state transition in which the number of subbuffers to be supplied with power is decreased, the buffer power management unit 15 may determine a target to be powered off based on whether any subbuffer 31 becomes empty. The buffer power management unit 15 determines a subbuffer 31 which has become empty as a target to be powered off.

Also, in the case where an individual state of one of the multiple subbuffers 31 is changed from “1” to “0” by a state transition, the buffer power management unit 15 stops power supply to the one subbuffer 31 after the one subbuffer 31 becomes empty. This prevents stopping power supply to a subbuffer 31 which is not empty.

Also, in the case where an individual state of one of the multiple subbuffers 31 is changed from “0” to “1” by a state transition, the buffer power management unit 15 starts power supply to the one subbuffer 31. This makes it possible to increase the number of subbuffers 31 being supplied with power.

Also, the command controller 12 allocates a subbuffer 31, of which individual state in a state indicated by the current state 154 is “1”, to data from the host 2. As a result, the data from the host 2 is allocated to the subbuffer 31 being supplied with power.

Also, in the case where none of the subbuffers 31, of which individual state is “1”, has an available space, the command controller 12 makes the host 2 keep on standby for sending data (or a host command). If the number of subbuffers 31 being supplied with power is small, a frequency of making the host 2 keep on standby for sending data is not changed or is increased, compared with the case where the number of subbuffers 31 being supplied with power is large. The frequency of making the host 2 keep on standby for sending data affects performance. Since the memory system 1 passively controls performance by controlling power consumption by a leakage current, performance degradation can be reduced, compared with the comparative example, in the case where the current power consumption value Pc exceeds the target value Pt.

Also, the buffer power management unit 15 estimates the current power consumption value Pc based on a temperature, a state indicated by the current state 154, and performance. As a result, the memory system 1 can acquire the current power consumption value Pc even in the case where the memory system 1 does not have a means for directly measuring the current power consumption value Pc.

In the above explanation, although only the operation concerning the write buffer 30 has been described, a similar operation is applicable to the read buffer 40. For example, the command controller 12 allocates a subbuffer 41, of which individual state is set to “1” in a state indicated by the current state 155, to data from the NAND memory 20. Also, the buffer power management unit 15 executes a state transition among multiple states defined in the state definition information 153 and records a state being selected on the current state 155. Also, the command controller 12 keeps on standby for data transfer from the NAND memory 20 to the read buffer 40, in the case where none of the subbuffers 41, being supplied with power and of which individual state is set to “1”, has an allocatable available space. The buffer power management unit 15 calculates the leakage power P1 based on the number of subbuffers 31 being supplied with power and the number of subbuffers 41 being supplied with power. Specifically, for example, the buffer power management unit 15 estimates the leakage power P1 based on a state indicated by the current state 154, a state indicated by the current state 155, and a temperature.

Also, the buffer power management unit 15 may collectively manage individual states with respect to each of the subbuffers #0 to #7 without distinguishing between the write buffer 30 and the read buffer 40. Specifically, for example, nine states can be defined by one state definition information. In each of the nine states, the number of subbuffers, of which individual state is set to “1”, among the subbuffers #0 to #7, is set to any of zero to eight, and also the number of the subbuffers, of which individual state is set to “1”, differs respectively. The buffer power management unit 15 executes a state transition among the nine states.

Also, the buffer power management unit 15 may estimate a future power consumption value based on the current power consumption value Pc and control the number of the subbuffers 31 based on comparison between the future value and the target value Pt. For example, the buffer power management unit 15 reduces the number of subbuffers 31 being supplied with power in the case where the future value is larger than the target value Pt, and increases the number of subbuffers 31 being supplied with power in the case where the future value is smaller than the target value Pt. Any method for estimating the future value can be used. For example, the buffer power management unit 15 may calculate the future value by extrapolating a transition of the current power consumption value Pc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system, comprising:
a nonvolatile memory;
a buffer memory divided into a plurality of first subbuffers;
a power management unit which acquires a power consumption value and starts and stops power supply to the first subbuffers with respect to each first subbuffer, based on the acquired power consumption value; and
a controller which selects a second subbuffer from one or more third subbuffers being supplied with power, and buffers transfer data between the outside and the nonvolatile memory in the second subbuffer.

2. The memory system according to claim 1, wherein the power management unit reduces the number of the third subbuffers in a case where the acquired power consumption value is higher than a target value, and increases the number of the third subbuffers in a case where the acquired power consumption value is lower than the target value.

3. The memory system according to claim 2, wherein the larger the difference between the acquired power consumption value and the target value is, the more the power management unit increases the amount of change in the number of the third subbuffers.

4. The memory system according to claim 3, wherein the power management unit stores definitions of multiple states, in which the numbers of subbuffers to be supplied with power are different respectively, and executes a state transition among the multiple states based on the acquired power consumption value.

5. The memory system according to claim 4, wherein the definitions of the multiple states include, for each of the multiple subbuffers, either a first individual state indicating that the power is supplied or a second individual state indicating that the power is not supplied.

6. The memory system according to claim 5, wherein, in a case where a state of one of the third subbuffers is changed from the first individual state to the second individual state by the state transition, the power management unit stops the power supply to the one subbuffer after the one subbuffer becomes empty.

7. The memory system according to claim 5, wherein, in a case where a state of one of fourth subbuffers is changed from the second individual state to the first individual state by the state transition, the power management unit starts the power supply to the one subbuffer, and
the fourth subbuffer is the first subbuffer not being supplied with the power.

8. The memory system according to claim 5, wherein the controller selects the second subbuffer from subbuffers in the first individual state among the multiple subbuffers with reference to the definition of a state being selected from the multiple states.

9. The memory system according to claim 8, wherein the controller, in a case where there is no subbuffer in the first individual state having an available space, causes the outside to keep on standby for sending the transfer data.

10. The memory system according to claim 1, wherein the power management unit estimates the power consumption value based on a temperature, the selected state, and a performance.

11. The memory system according to claim 1, wherein the power management unit predicts a future power consumption value based on the acquired power consumption value, and reduces the number of the third subbuffers in a case where the future value is larger than a target value, and increases the number of the third subbuffers in a case where the future value is smaller than the target value.
